(19) United States
(12) Patent Application Publication
(10) Pub. No.: US 2007/0273490 A1
(43) Pub. Date: Nov. 29, 2007

(54) Device and Method for Detecting a Momentary Distance Between a Motor Vehicle and an Obstacle

(75) Inventors: Alexander Fuchs, Sindelfingen (DE); Manfred Steiner, Winnenden (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/570,800

(22) PCT Filed: Aug. 21, 2004
(86) PCT No.: PCT/EP04/09382

§ 371 Date: Feb. 13, 2007

(30) Foreign Application Priority Data
Sep. 6, 2003 (DE) 103 41 128.3

(51) Int. Cl. G01S 13/93; G08B 21/18

(52) U.S. Cl. 340/435; 342/118

(57) ABSTRACT

A device for detecting a momentary distance between a motor vehicle and an obstacle is provided. The device includes distance sensors and a control unit that is designed to calculate a driving path to be traveled through in future by the motor vehicle. The driving path is calculated using dynamic vehicle data and the control unit is designed to differentiate between relevant obstacles which are located within the driving path, and irrelevant obstacles which are located outside the driving path. A method for detecting a momentary distance between a motor vehicle and an obstacle is also provided.

### BACKGROUND AND SUMMARY OF THE INVENTION

The invention relates to a device for detecting a momentary distance between a motor vehicle and an obstacle and also to an associated method.

Devices of the generic type are known, for example, by the designation “Parktronic” for the applicant. Such a device can be used to facilitate maneuvering for the driver of the vehicle in restricted traffic conditions with poor visibility, in particular when parking, by virtue of the fact that the driver is warned about obstacles which are located in his direction of travel and whose distance from the vehicle is smaller than a predefined limiting distance. Such obstacles may be, for example objects which are lying around or else moving obstacles such as other road users.

DE 198 47 013 A1 discloses a parking assistance system for a vehicle which comprises a measuring device for measuring the momentary distance between the vehicle and an obstacle, an evaluation device and a warning signal transmitter. The evaluation device compares a distance signal which has been output by the measuring device with a distance limiting value, the warning signal transmitter generating a warning signal, which can be perceived by a driver of the vehicle, as long as the distance signal exceeds the distance limiting value. According to one predefined function of the movement state of the vehicle, the evaluation device defines the distance limiting value dynamically in this context. As a result it also provides the driver even at a relatively high velocity with the reaction time which is necessary in order to bring the vehicle reliably to a stop before the obstacle.

DE 199 01 847 A1 discloses a method as a device for detecting objects, in particular as a parking assistance device in a motor vehicle. The device comprises a number of distance sensors, at least one microcontroller which actuates the distance sensors, and an output unit, it being possible for the microcontroller to apply an identifier which varies over time to the distance sensors. By applying this identifier which is variable over time to the distance sensors it is possible to assign the received signals reliably to the sources in uniquely defined fashion. As a result the risk of the distance measurement being adversely affected, as a result of, for example, transmitted signals from distance sensors of other vehicles, is reduced.

WO 98/20364 discloses a method for distance measurement of obstacles from a vehicle using an echo method, preferably an ultrasonic method, in which the transmission signal from the object subject to radiation is bounced back to the vehicle in the form of an echo and a warning signal is triggered in the vehicle during a chronological listening window as a function of the threshold value of the receiver. The chronological position and/or the duration of the transmission signal and/or the variation of the threshold value over time during the listening window depend on the data of the vehicle. If, for example, the front wheels of the vehicle are locked by a specific angle, it is not necessary to measure in the remote region on the side of the vehicle which will not reach this remote region owing to the angular position of the wheels. In this case, the listing window can end earlier. However, the vehicle movement dynamic data of the vehicle can also be used to change the measuring parameters of the distance measurement. The described method is conceived specifically for gating out undesired echoes in the direct proximity of the motor vehicle. For this reason, for example the sensitivity of an electro-acoustic transducer can be adapted to the surface on which the vehicle is traveling or to attachments of the motor vehicle such as a trailer hitch.

WO 99/32318 discloses a regulating system for the velocity and distance when a motor vehicle changes lane. In a distance-related velocity-regulating system for motor vehicles with an electronic control unit, the electronic control unit registers at least one signal for detecting a change of lane or a request for a change of lane from the instantaneous lane to a target lane and at least one signal for estimating the average velocity of vehicles on the target lane. In the case of a change of lane or request for a change of lane, the control unit prescribes the vehicle velocity and/or the distance from the vehicle traveling ahead on the momentary lane, in accordance with this average velocity.

EP 1 318 491 A1 discloses a method for detecting obstacles which are located ahead of a vehicle, by adapting the predicted lane width as a function of navigation system data. As a result, the vehicle behavior is improved within the scope of a velocity control system.

DE 199 34 670 A2 and WO 03/064215 A1 disclose an object detection system having a plurality of detectors with different detection ranges. Each of the detectors has a permanently assigned monitored area. The detection range of a detector is not controlled. Instead, a decision is made as to which objects are to be considered irrelevant on the basis of the collected data.

DE 101 49 146 A1 discloses a velocity regulator with a distance function for motor vehicles having a locating system for detecting the locating data for objects which are located ahead of the vehicle, having an evaluation device for deciding whether a located object is to be treated as a relevant target object on the vehicle's own lane. The sensors are operated with constant power so that their power is not controlled by the locating system.

The present invention is therefore concerned with the problem of specifying, for a device of the type mentioned at the beginning, an improved embodiment which improves, in particular, the comfort of the device and thus its acceptance in order to increase the traveling safety.

In accordance with exemplary embodiments of the present invention, a control unit of a device for detecting a momentary distance between a motor vehicle and an obstacle is constructed in such a way that said control unit can calculate a driving path, to be traveled through in future by the motor vehicle, using dynamic vehicle data, and in addition is able to differentiate relevant obstacles which are located within the driving path from irrelevant obstacles which are located outside the driving path.

Conventional distance sensors detect all the obstacles which are located in their respective detection area, irrespective of whether they constitute a relevant or an irrelevant obstacle in view of the direction of travel for the motor vehicle. The invention therefore provides for only objects and obstacles within the driving path, i.e. within the area which is relevant to the motor vehicle, to be registered as a potential collision object.

The driving path is calculated using static data which is stored in the control unit, for example a vehicle contour, and dynamic vehicle data, for example the direction of travel, the vehicle velocity or the steering angle, and thus ensures that a clear distinction is made between relevant objects or obstacles within the driving path and irrelevant objects or obstacles which are located outside the driving path and therefore cannot be reached by the motor vehicle, or cannot adversely affect it.

In comparison to previously known systems for distance detection between motor vehicles and an obstacle located ahead in the direction of travel, this constitutes a significant improvement in the detection accuracy and thus an improvement in the traveling safety.

According to one preferred embodiment there may be provision for the range of the distance sensors which each have a variable detection area to be limited by the control unit to the driving path. The control unit is designed here to adapt the range of the detection areas of the distance sensors to lateral boundaries of the driving path. Additionally or alternatively, objects which are detected outside the driving path can be classified as irrelevant objects or obstacles and gated out. This basically provides the possibility of differentiating the relevant obstacles from the irrelevant obstacles in two ways which can each be applied independently or in combination, and of thus improving the functional safety of the system.

According to one preferred embodiment there may be provision for those distance sensors whose detection area is located completely in the driving path to be actuated by the control unit in such a way that they operate with maximum range. This provides the advantage that the distance sensors detect obstacles which are located in the area which is relevant to the vehicle early. The earliest possible detection reduces the risk of collision between the vehicle and the relevant object and thus contributes significantly to improving the traveling safety.

According to one advantageous embodiment of the solution according to the invention, the control unit can be connected to a brake device for the motor vehicle and can be designed to automatically brake the motor vehicle. If a sensor detects an obstacle which is located in the driving path and is thus relevant, it signals to the control unit which automatically brakes the motor vehicle and thus reduces a risk of collision. The braking force which is applied in the process and with which the vehicle is braked, may be dependent here on the control unit, for example as a function of the range of the distance sensors, the velocity or the position of the obstacle in the driving path, and thus permit a braking process which is adapted individually to the respective situation.

The distance sensors can expediently be embodied as ultrasonic sensors. Ultrasonic sensors are robust components which have been well proven over many years in motor vehicles and which are economic to manufacture and can be adapted individually to a wide variety of requirements. Generally, however, other sensors based on electromagnetic waves or sound waves, for example radar sensors, are also conceivable.

Furthermore, the distance sensors can be arranged on the front of a vehicle and/or on the rear of a vehicle. As a result it is possible to calculate the driving path to be traveled through in the future both when traveling forward and when traveling backward, and to adapt the detection areas of the sensors to a respective driving path which is located ahead of the motor vehicle in the direction of travel. In addition it is possible to provide that only the distance sensors which are located on the front of the motor vehicle in the direction of travel are activated, while the distance sensors which are located at the rear of the motor vehicle in the direction of travel are inactive.

Further important features and advantages of the invention emerge from the claims, from the drawings and from the associated description of the figures with reference to the drawings.

It goes without saying that the features mentioned above and the features to be explained below can be used not only in the respectively specified combination but also in other combinations or alone without departing from the scope of the present invention.

### BRIEF DESCRIPTION OF THE DRAWING FIGURES

Preferred exemplary embodiments of the invention are illustrated in the drawings and are explained in more detail in the following descriptions, with reference symbols referring to identical or similar or functionally identical components.

Other objects, advantages and novel features of the present invention will become apparent from the following detailed description of the invention when considered in conjunction with the accompanying drawings.

In said drawings:

FIG. 1 shows a motor vehicle with distance sensors with maximum detection areas,

FIG. 2 shows an illustration as in FIG. 1 but with adapted detection areas during straight-ahead travel, and

FIG. 3 shows an illustration as in FIG. 2 but during cornering.

### DETAILED DESCRIPTION OF THE PREFERRED EMBODIMENTS

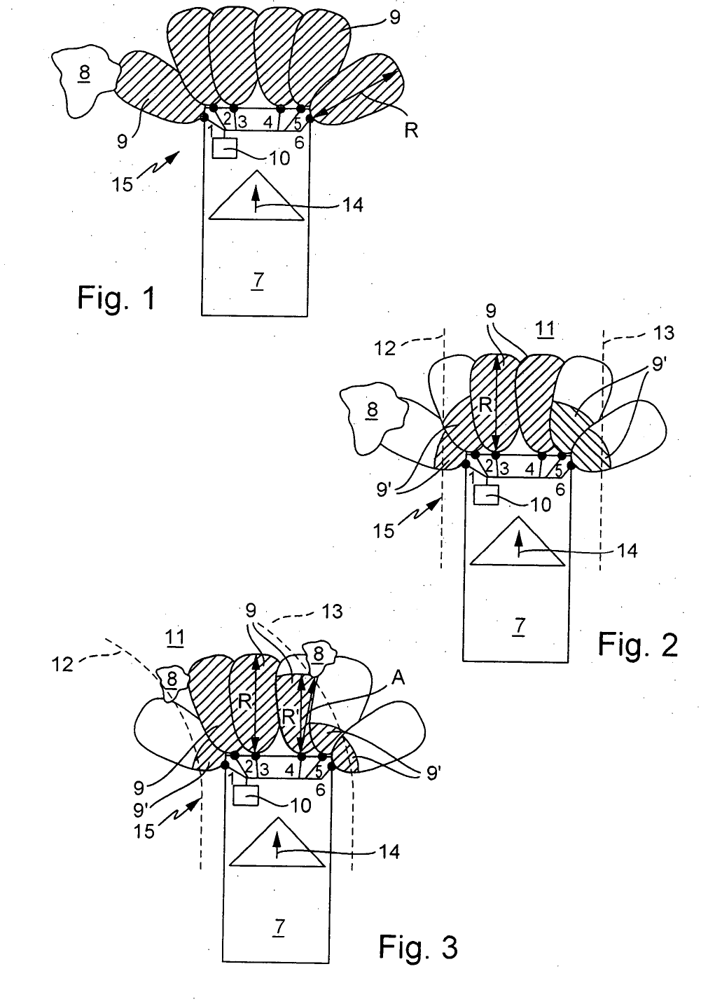

According to FIG. 1, a device 15 has a plurality of distance sensors 1 to 6 which are arranged located on the front of a motor vehicle 7 in the direction 14 of travel. The device 15 is designed to detect a momentary distance A between the motor vehicle 7 and an obstacle 8. The number of distance sensors 1 to 6 illustrated in FIG. 1 is variable here. In addition it is conceivable for further distance sensors, not shown, in addition to the distance sensors 1 to 6, to be arranged on the back of the motor vehicle 7 in the direction 14 of travel. The distance sensors 1 to 6 respectively transmit a radiation lobe which detects a variable detection area 9. The maximum extent of the detection area 9 is characterized here by a range Rₘₐₓ. All the distance sensors 1 to 6 are connected, via connecting lines not designated in more detail, to a control unit 10 which is capable of controlling or adapting the range R of the individual detection areas 9 independently of one another.

According to FIG. 1, all the detection areas 9 of the distance sensors 1 to 6 have their maximum range Rₘₐₓ and thus also sense side regions which the motor vehicle 7 does not reach owing to the direction 14 of travel. This means that a possible obstacle 8, here in the form of a tree, is detected by the distance sensor 1 without said tree directly impeding the motor vehicle 7. This is what is referred to as an irrelevant obstacle 8 since it does not project into a possible driving area or driving path 11 (cf. FIGS. 2 and 3) of the motor vehicle 7.

In order to differentiate between relevant obstacles 8′ which are located within the driving path 11 and constitute a direct risk of collision of the moving motor vehicle 7, and an irrelevant obstacle 8 which is located outside the driving path 11, the control unit 10 is designed to calculate a driving path 11 which will be traveled through in future by the motor vehicle, using dynamic vehicle data, for example, the vehicle velocity or the direction 14 of travel, and static vehicle data, for example a structural vehicle contour, as well as for adapting the detection areas 9 of the distance sensors 1 to 6 to the calculated driving path 11. In addition or alternatively, the control unit 10 can, for example, gate out, by a limiting means in the form of software, obstacles 8 which are detected but are not relevant.

The differentiation between relevant obstacles 8′ which are located inside the driving path 11 and irrelevant obstacles 8 outside the driving path 11 is thus basically possible in two ways. The two aforementioned differentiation mechanisms (limitation of the detection areas 9 of the distance sensors 1-6 to lateral boundaries 12, 13 of the driving path 11 and the software gating out of objects outside the driving path 11) can be applied alone or together here.

According to FIG. 2, the device 15 according to the invention is shown in the activated state when the motor vehicle 7 is traveling straight ahead. The control unit 10 calculates the driving path 11 which will be traveled through in future by the motor vehicle 7 and which is located ahead of the motor vehicle 7 in the direction of travel between the two lateral boundaries 12 and 13. The control unit 10 controls here the range R of the detection areas 9 of the individual distance sensors 1 to 6 as a function of the two boundaries 12 and 13, with the distance sensors 3 and 4 and their detection areas 9 being located completely in the driving path 11, and are actuated by the control unit 10 in such a way that they operate with maximum range Rₘₐₓ while the distance sensors 1, 2 and 5, 6 are actuated by the control unit 10 in such a way that their detection area 9′ is located essentially within the driving path 11 and is limited in its extent by the lateral boundaries 12 and 13.

The illustrated obstacle 8, which is located outside the driving path 11, is thus, in contrast to FIG. 1, not detected by the distance sensor 1. Alternatively, it is possible, as mentioned above, for the obstacle 8 which is located outside the driving path 11 to be detected but for it to be classified as an irrelevant object 8 by the control unit 10 and gated out.

According to FIG. 3, the device 15 according to the invention is also in the activated state but is illustrated when cornering. Here, the two distance sensors 2 and 3 are at their maximum range Rₘₐₓ, while the distance sensors 1, 4, 5 and 6 are limited in their range R′. The control unit 10 calculates here, with reference to the static and dynamic vehicle data, the driving path 11 to be traveled through by the motor vehicle 7 during cornering in particular with reference to the steering angle, and it adapts the range R′ to the lateral boundaries 12 and 13 of the driving path 11. The object or obstacle 8 which is located outside the driving path 11 is not detected or registered by the reduced range R′ of the distance sensor 4 according to FIG. 3. In contrast, the relevant object 8′ which is located on the driving path 11 to be traveled through in future by the vehicle 7 is detected by the distance sensor 2. This is also explained appropriately for the methods of differentiation.

The control unit 10 is connected here to a brake device (not illustrated) of the motor vehicle 7 and brings about automatic braking of the motor vehicle 7 by means of a control signal which is emitted by the control unit 10. The automatic braking avoids a collision of the motor vehicle 7 with the obstacle 8′ and thus increases the traveling safety.

The distance sensors 1 to 6 may be embodied as sensors with different measuring methods, for example ultrasonic, radar or optical sensors, and may be arranged on the front of the vehicle and/or on the rear of the vehicle. The detection areas 9 are adapted dynamically by the control unit 10 as a function of the momentary vehicle data such as, for example, the vehicle velocity, direction 14 of travel, vehicle acceleration, change in steering angle, sensor function or measuring methods.

The invention provides for a control unit 10 of a device 15 for detecting a momentary distance A between a vehicle 7 and an obstacle 8, 8′ to be designed in such a way that said control unit 10 can calculate a driving path 11, to be traveled through in future by the vehicle 7, using the static and dynamic vehicle data, and is also able to differentiate relevant obstacles 8′ which are located within the driving path 11, and irrelevant obstacles 8 which are located outside the driving path 11.

The calculation of the driving path 11 thus ensures precise differentiation between relevant and irrelevant objects or obstacles 8 and 8′, as a result of which the traveling safety can be improved.

Those distance sensors 1 to 6 whose detection area is located completely on the driving path 11 are actuated here by the control unit 10 in such a way that they operate with maximum range Rₘₐₓ. This provides the advantage that the obstacles 8′ which are located in this area are detected early.

Furthermore, the control unit 10 can be connected to a brake device of the motor vehicle 7 and be designed to automatically brake the motor vehicle 7. If a distance sensor 1 to 6 detects an obstacle 8′ which is located in the driving path 11 and is thus relevant, it signals this to the control unit 10 which automatically brakes the motor vehicle 7 and thus reduces a risk of collision.

The distance sensors 1 to 6 may be arranged optionally on the front of a vehicle and/or on the rear of a vehicle here.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-16. (canceled)

17. A device for detecting a momentary distance between a motor vehicle and an obstacle, the device comprising:
distance sensors; and
a control unit,
wherein the control unit is arranged to calculate a driving path to be traveled through in future by the motor vehicle, using static and dynamic vehicle data, and the control unit is arranged to differentiate between relevant obstacles which are located within the driving path and irrelevant obstacles which are located outside the driving path, and
wherein the distance sensors each have a variable detection area, the control unit is arranged to adapt the range of the detection areas of the distance sensors to lateral boundaries of the driving path, and the distance sensors whose detection area is located completely in the driving path are actuated by the control unit in such a way that they operate with maximum range (Rₘₐₓ).

18. The device as claimed in claim 17, wherein the control unit is arranged to gate out irrelevant obstacles which are detected.

19. The device as claimed in claim 17, wherein the control unit is connected to a brake device of the motor vehicle and is arranged to automatically brake the motor vehicle.

20. The device as claimed in claim 17, wherein the distance sensors are ultrasonic, radar or optical sensors.

21. The device as claimed in claim 17, wherein the distance sensors are arranged on the front of a vehicle and/or on the rear of a vehicle.

22. The device as claimed in claim 17, wherein the dynamic vehicle data includes vehicle velocity, direction of travel, vehicle acceleration, steering angle, change in steering angle, or sensor function.

23. The device as claimed in claim 18, wherein at least one vehicle contour is used as static vehicle data.

24. A method for detecting a momentary distance between a motor vehicle and an obstacle, the vehicle having distance sensors and having a control unit, the method comprising the acts of:
calculating by the control unit a driving path to be traveled through by the motor vehicle using static and dynamic vehicle data;
differentiating relevant obstacles within the driving path from irrelevant obstacles which are located outside the driving path; and
controlling, by the control unit, the range of the detection areas of the individual distance sensors in such a way that distance sensors whose distance areas are located completely on the driving path operate with maximum range while other distance sensors are actuated outside their maximum range so that their detection area is located essentially within the driving path.

25. The method as claimed in claim 24, wherein the distance sensors each have a variable detection area, and the control unit adapts the range of the detection areas of the distance sensors to lateral boundaries of the driving path.

26. The method as claimed in claim 24, wherein the control unit gates out irrelevant obstacles which have been detected.

27. The method as claimed in claim 24, wherein the control unit is connected to a brake device of the motor vehicle, and the motor vehicle is braked automatically in response to a control signal of the control unit.

28. The method as claimed in claim 24, wherein the distance sensors operate with a measuring principle which is based on electromagnetic waves or sound waves.

29. The method as claimed in claim 24, wherein the driving path is calculated using vehicle velocity, direction of travel, vehicle acceleration, steering angle, change in steering angle, sensor function, or vehicle contour.
